(19) United States
(12) Patent Application Publication
(10) Pub. No.: US 2013/0115580 A1
(43) Pub. Date: May 9, 2013

(54) Learning another Language through Song

(71) Applicant: Dorothy Ann Lundy, Renton, WA (US)

(72) Inventor: Dorothy Ann Lundy, Renton, WA (US)

(21) Appl. No.: 13/267,684

(22) Filed: Nov. 4, 2011

(51) Int. Cl. G09B 19/06

(52) U.S. Cl. CPC G09B 19/06
USPC 434/157

(57) ABSTRACT

This application is for the purpose of obtaining a Utility Patent titled “Learn another Language through Song”. This method is a new way to learn another language. As explained in the application another language will be learned almost entirely through one line, or chorus or verse in one language and repeated in a second language in song.

### §1.73 DETAILED DESCRIPTION AND SPECIFICATION

This is an application for a Utility Patent for a new method to learn another language through song. A song is sung in whole or parts in two languages, to help the listener learn how to understand another language.

### §1.73 SUMMARY OF THE INVENTION

This is an application for a Utility patent for “Learn another Language through Song”, this invention is a new and useful way to learn another language. A song is sung in whole or parts in two languages, to help the listener learn how to understand another language.

### SPECIFICATION

Description, songs will be sung in two languages, song lines, or phrases, or chorus will be in one language then repeated in another language this will help the listener learn another language.

Feature description. Words or phrases from songs will be repeated in a different/second language. For instance: In song, What's Happening? Then repeated in song, Que Pasa? The songs will range from simple to complex.

1. I claim that learning an additional language through song is a new use for learning another language. Songs are song in two languages and will enable the listener to learn pronunciation and words of another language.
